(19) United States
(12) Patent Application Publication
(10) Pub. No.: US 2014/0226210 A1
(43) Pub. Date: Aug. 14, 2014

(54) PLASTIC FILM, DISPLAY DEVICE, AND MULTI DISPLAY DEVICE

(71) Applicant: Hiroyuki Moriwaki, Osaka (JP)

(72) Inventor: Hiroyuki Moriwaki, Osaka (JP)

(73) Assignee: SHARP KABUSHIKI KAISHA, Osaka (JP)

(21) Appl. No.: 14/117,611

(22) PCT Filed: May 9, 2012
(86) PCT No.: PCT/JP2012/003026

§ 371 Date: Nov. 13, 2013

(30) Foreign Application Priority Data
May 16, 2011 (JP) 2011-109087

(51) Int. Cl. G02B 1/11

(52) U.S. Cl. CPC G02B 1/11
USPC 359/601; 428/141; 428/354

(57) ABSTRACT

A plastic film provided with a base film (1) exhibiting heat shrinkability, and a reflection inhibitor (Sf) disposed on the base film (1) and for inhibiting the reflection of external light.

### TECHNICAL FIELD

The present invention relates to a plastic film, a display device and a multi-display device, and in particular, relates to a multi-display device and a display device included in the multi-display device, and a plastic film used therein to mitigate the reflection of external light.

### BACKGROUND ART

In recent years, there has been attention on a multi-display device having a plurality of display devices arranged in a matrix therein as a large display device used in applications such as digital signage.

Patent Document 1, for example, discloses a display device provided with a magnifying lens in seams between adjacent monitors.

### RELATED ART DOCUMENT

### Patent Document

Patent Document 1: Japanese Patent Application Laid-Open Publication No. 2010-72522

### SUMMARY OF THE INVENTION

### Problems to be Solved by the Invention

In a multi-display device, as disclosed in Patent Document 1, in order to make the seams between the respective display devices difficult to see, a configuration is often used in which a frame-shaped lens member formed into a substantially semicircular shape in a cross-sectional view is provided in the periphery of each display device. In the respective display devices constituting the multi-display device, in some cases, a plastic film is bonded to the surface of the lens member in order to mitigate the reflection of external light, thus mitigating ghost images on the surface of the lens member. Here, the surface of the lens member is formed into a curved shape, and in particular, the corner portions of the frame-shaped lens member have a surface shape in which two different curved surfaces are connected together, for example, thus resulting in the bonded plastic film being susceptible to wrinkling and the like, which makes the bonding of the plastic film difficult.

The present invention takes into account the problem above, and an object thereof is to bond with ease a plastic film for mitigating the reflection of external light.

### Means for Solving the Problems

In order to attain the object above, the present invention applies heat-shrinking properties to a plastic film for mitigating reflection of external light.

Specifically, the plastic film according to the present invention includes: a base film having a heat-shrinking property; and a reflection inhibitor in or on the base film that mitigates reflection of external light.

According to the configuration above, by providing a reflection inhibitor in or on the base film, reflection of external light is mitigated, and because the base film has heat-shrinking properties, the plastic film for mitigating reflection of external light has heat-shrinking properties. Thus, if bonding a plastic film to a bonding surface that is curved, then by rolling the plastic film into a cylinder and disposing an object having the bonding surface therein through a coating film, adhesive film, or the like that is an ultraviolet curable or heat curable resin, it is possible to heat-shrink the base film included in the plastic film by heating the plastic film, and to evenly bond the plastic film onto the bonding surface. As a result, the plastic film is bonded to the bonding surface with ease, and thus, even if the bonding surface is curved, it is possible to bond the plastic film for mitigating reflection of external light thereon with ease.

The reflection inhibitor may include a reflection inhibitor film that is provided on a front surface of the base film and that mitigates reflection of external light.

According to this configuration, the reflection inhibitor is constituted of a reflection inhibitor film that is provided on the front surface of the base film and that mitigates reflection of external light, and thus, by layering the reflection inhibitor film onto the base film, a plastic film for mitigating reflection of external light is specifically formed.

The reflection inhibitor film may include an antiglare film that is provided on the front surface of the base film and that has undergone roughening treatment, an antireflector film having a plurality of dielectric films that are layered, or a multilayer film having the antiglare film and the antireflector film layered in that order.

According to the configuration above, the reflection inhibitor film is constituted of the antiglare film that is provided on the front surface of the base film and that has undergone roughening treatment, the antireflector film that is provided on the front surface of the base film and that includes a plurality of layered dielectric films, or a multilayer film that is provided on the front surface of the base film and that includes the antiglare film and the antireflector film layered in that order, a plastic film for mitigating reflection of external light is specifically formed by the base film and the antiglare film layered thereon, the base film and the antireflector film layered thereon, or the base film and the antiglare film and antireflector film layered thereon.

The reflection inhibitor film may include a resin film having thermoplasticity that is provided on the front surface of the base film, and particles that are dispersed in the resin film and that mitigate reflection of external light by light dispersion at particle surfaces.

According to the configuration above, the reflection inhibitor film includes a resin film having thermoplasticity that is provided on the front surface of the base film and particles dispersed in the resin film, and thus, the plastic film for mitigating reflection of external light is constituted of the base film and the resin film including dispersed particles that is layered thereon. Therefore, even if the base film has a high rate of heat-shrinkage, it is possible for the resin film to conform to the heat-shrinkage of the base film with ease.

The reflection inhibitor may be constituted of particles that are dispersed in the base film and that mitigate reflection of external light by light dispersion at particle surfaces.

According to the configuration above, the reflection inhibitor is constituted of the particles dispersed in the base film, and thus, even if the heat-shrinkage rate of the base film is high, it is possible for the reflection inhibitor to conform to the heat-shrinkage of the base film with ease.

A rear surface of the base film may be provided with an adhesive film, and the reflection inhibitor may be constituted of particles that are dispersed in the adhesive film and that mitigate reflection of external light by light dispersion at particle surfaces.

According to the configuration above, the reflection inhibitor is constituted of the particles dispersed in the adhesive film layered on the base film, and thus, even if the heat-shrinkage rate of the base film is high, it is possible for the reflection inhibitor to conform to the heat-shrinkage of the base film with ease.

A rear surface of the base film may be provided with an adhesive film.

According to the configuration above, the adhesive film is provided on the rear surface of the base film, and thus, the adhesive film is disposed with ease between the base film included in the plastic film for mitigating reflection of external light, and the curved bonding surface.

Also, the display device according to the present invention, includes: a display panel having a display region that performs image display; a lens member that is provided in a frame shape so as to cover a periphery of the display panel and that guides display light in a periphery of the display region of the display panel towards an outside of the display region; and a plastic film provided so as to cover a surface of the lens member, the plastic film including a base film that has been heat-shrunk and a reflection inhibitor in or on the base film that mitigates reflection of external light.

According to the configuration above, in the plastic film for mitigating reflection of external light that covers the surface of the lens member, the reflection inhibitor provided on the base film allows the reflection of external light to be mitigated, and the base film heat-shrinks (when bonding, the base film having heat-shrinking properties before bonding, for example). Therefore, by rolling the plastic film into a cylinder and disposing the lens member therein through a coating film, adhesive film, or the like that is an ultraviolet curable or heat curable resin, and heating the plastic film, the base film included in the plastic film heat-shrinks, and thus, it can be inferred that the plastic film is evenly bonded onto the lens member. As a result, the plastic film is bonded with ease onto the surface of the lens member, and thus, a plastic film for mitigating reflection of external light is bonded with ease onto the lens member provided so as to cover the periphery of the display panel.

The lens member may include four linear portions constituting four sides of a rectangle, and four corner portions that respectively connect adjacent linear portions to each other.

According to the configuration above, the lens member includes four linear portions and four corner portions, and thus, by bonding the plastic film for mitigating reflection of external light for the respective linear portions and the respective corner portions that constitute the lens member, the plastic film is bonded with ease onto the lens member. Also, the respective linear portions included in the lens member have a simple curved surface, and thus, a base film that does not have heat-shrinking properties may be used.

A multi-display device according to the present invention may include a plurality of the above-mentioned display devices, and the plurality of display devices may be arranged in a matrix.

According to the configuration above, in each display device, it is possible to easily bond the plastic films for mitigating reflection of external light to the lens member provided so as to cover the periphery of the display panel, and thus, a larger displaying is attained having seams between the respective display devices do not stand out (seamless).

### Effects of the Invention

According to the present invention, the plastic film for mitigating light reflection is provided with heat-shrinking properties, and thus, it is possible to bond the plastic film for mitigating light reflection with ease.

### BRIEF DESCRIPTION OF THE DRAWINGS

FIG. 1 is a plan view of a multi-display device according to Embodiment 1.

FIG. 2 is a schematic view of a configuration of the multi-display device according to Embodiment 1.

FIG. 3 is a cross-sectional view of a liquid crystal display device included in the multi-display device according to Embodiment 1.

FIG. 4 is a plan view of a lens member included in the liquid crystal display device according to Embodiment 1.

FIG. 5 is a perspective view of a linear portion included in the lens member of Embodiment 1.

FIG. 6 is a perspective view of a corner portion included in the lens member of Embodiment 1.

FIG. 7 is a cross-sectional view of a plastic film included in the liquid crystal display device according to Embodiment 1.

FIG. 8 is a cross-sectional view of a Modification Example 1 of a plastic film included in the liquid crystal display device of Embodiment 1.

FIG. 9 is a cross-sectional view of a Modification Example 2 of a plastic film included in the liquid crystal display device of Embodiment 1.

FIG. 10 is a perspective view showing a method of bonding the plastic film onto the linear portion of the lens member of Embodiment 1.

FIG. 11 is a perspective view showing a method of bonding the plastic film onto the corner portion of the lens member of Embodiment 1.

FIG. 12 is a perspective view showing another method of bonding the plastic film onto the linear portion of the lens member of Embodiment 1.

FIG. 13 is a cross-sectional view of a plastic film according to Embodiment 2.

FIG. 14 is a cross-sectional view of a plastic film according to Embodiment 3.

FIG. 15 is a cross-sectional view of a plastic film according to Embodiment 4.

### DETAILED DESCRIPTION OF EMBODIMENTS

Embodiments of the present invention will be described in detail below with reference to drawings. The present invention is not limited to the embodiments below.

### Embodiment 1

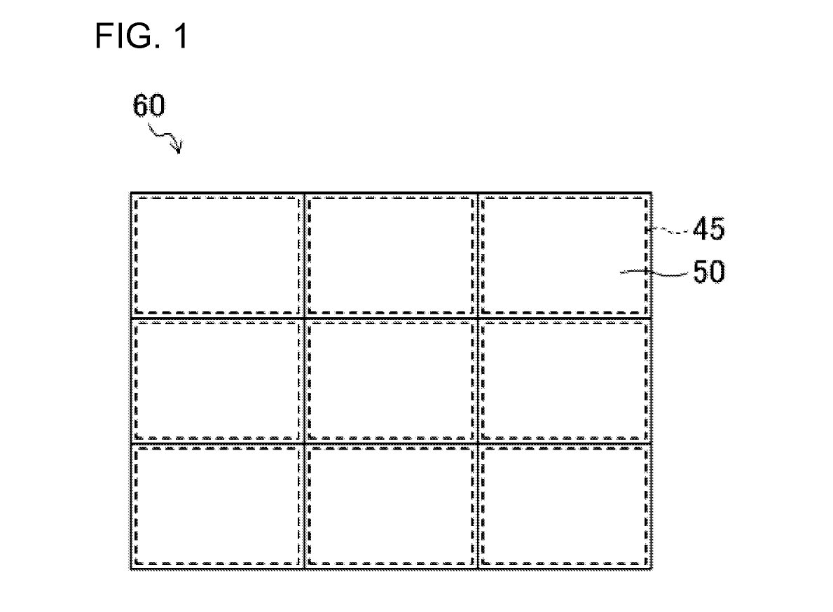

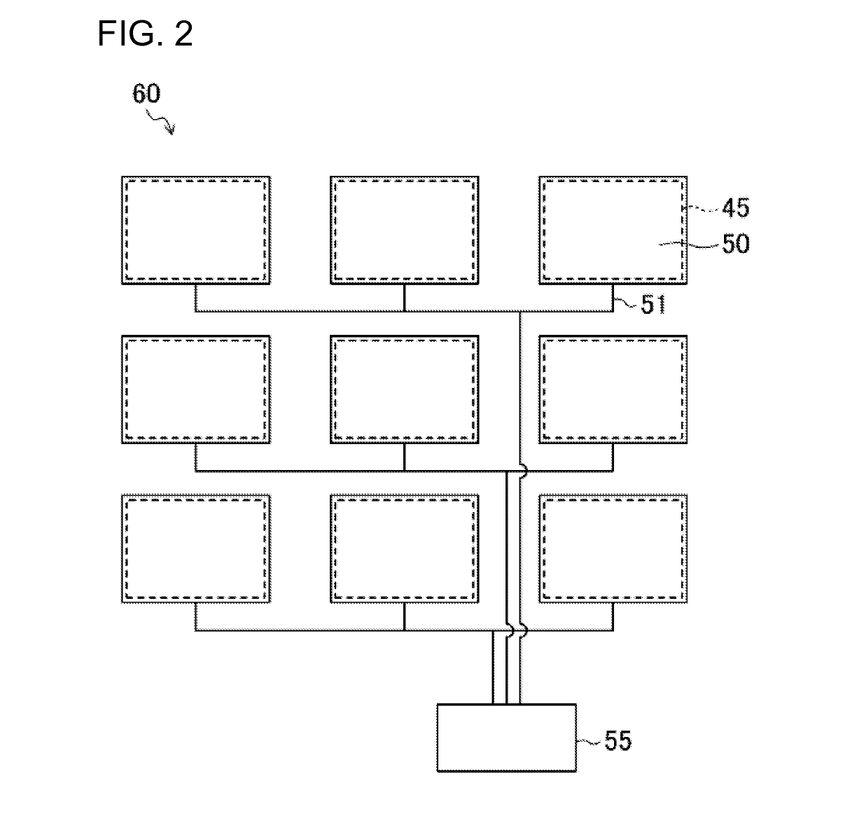

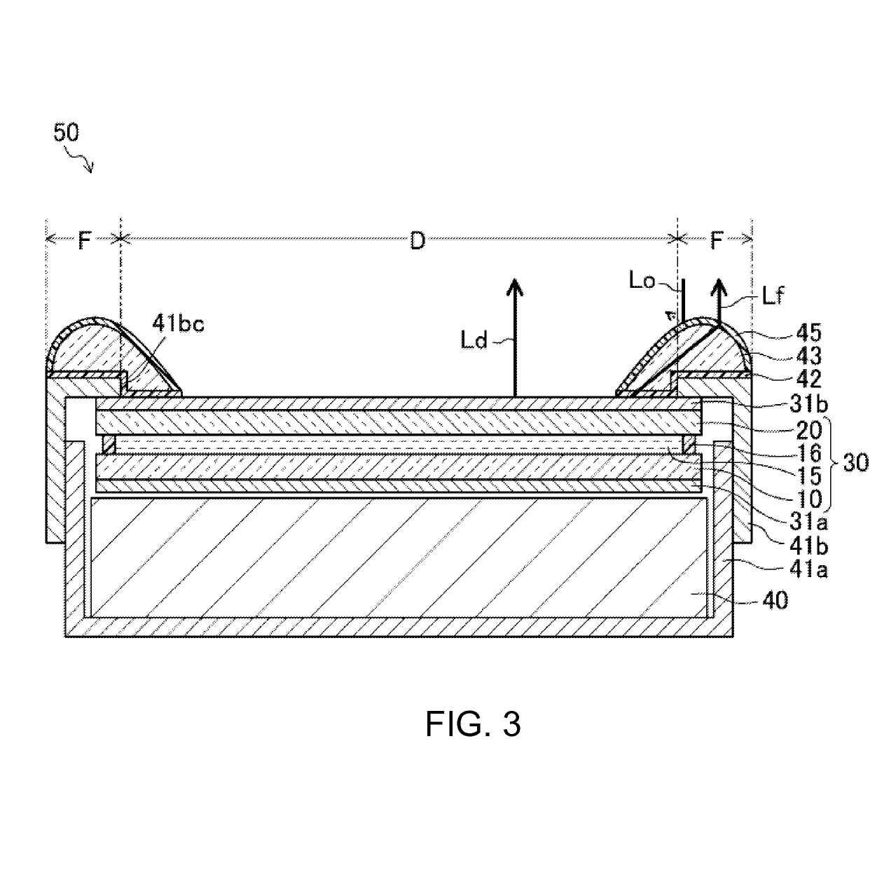

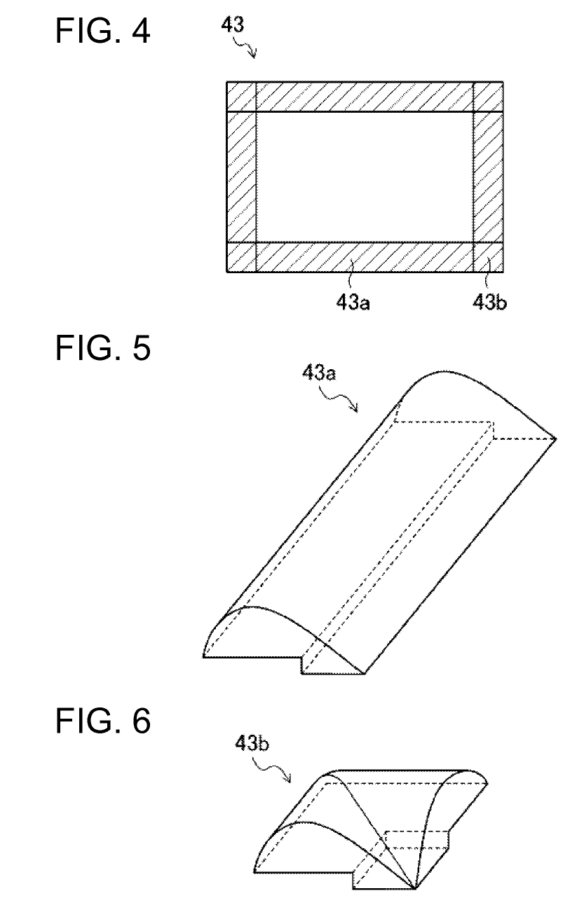

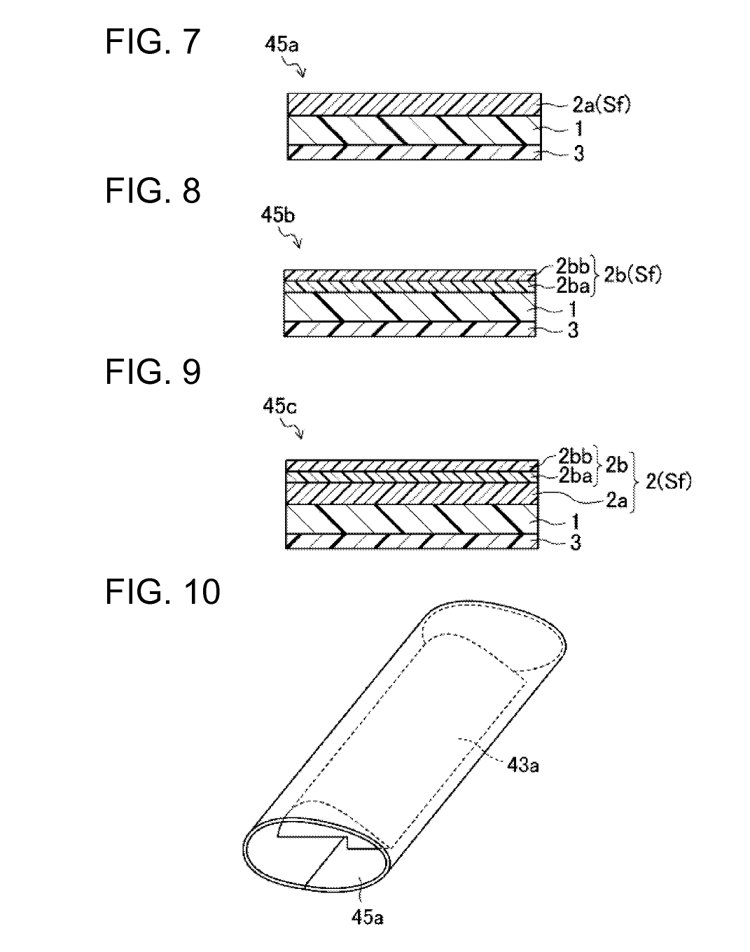

FIGS. 1 to 12 show Embodiment 1 of a plastic film, a display device, and a multi-display device according to the present invention. Specifically, FIG. 1 is a plan view of a multi-display device 60 of the present embodiment. FIG. 2 is a schematic view of a configuration of the multi-display device 60. FIG. 3 is a cross-sectional view of a liquid crystal display device 50 included in the multi-display device 60. FIG. 4 is a plan view of a lens member 43 included in the liquid crystal display device 50. FIG. 5 is a perspective view of a linear portion 43a included in the lens member 43. FIG. 6 is a perspective view of a corner portion 43b included in the lens member 43. FIG. 7 is a cross-sectional view of a plastic film 45a for forming a plastic film 45 included in the liquid crystal display device 50. FIG. 8 is a cross-sectional view of a plastic film 45b of Modification Example 1 of the plastic film 45a. FIG. 9 is a cross-sectional view of a plastic film 45c of Modification Example 2 of the plastic film 45a.

As shown in FIGS. 1 and 2, the multi-display device 60 includes 3×3 (9 total) liquid crystal display devices 50 arranged in a matrix, a controller 55 for controlling the respective liquid crystal display devices 50, connecting cables 51 for connecting the respective liquid crystal display devices 50 to the controller 55, and a metal frame (not shown in drawings) provided so as to house and fix the liquid crystal display devices 50. In the present embodiment, a configuration in which the respective liquid crystal display devices 50 are connected in parallel is described as an example, but the respective liquid crystal display devices 50 may be connected in series by a GPIB (general purpose interface bus) interface board or the like.

The controller 55 is configured so as to send contents to display to the respective liquid crystal display devices 50 and switch display modes for the respective liquid crystal display devices 50. The multi-display device 60 is thus configured such that the whole multi-display device 60 (nine liquid crystal display devices 50) display one image or the respective liquid crystal display devices 50 display the same or different images based on the signal from the controller 55.

The frame is configured so as to be able to be separated into a plurality of parts, and it is possible to freely change the size depending on the number of liquid crystal display devices 50 included.

As shown in FIG. 3, the liquid crystal display device 50 includes: a liquid crystal display panel 30; a pair of polarizing plates 31a and 31b bonded on a rear surface (lower side of drawing) and a front surface (upper side of drawing) of the liquid crystal display panel 30; a backlight 40 provided on the rear surface of the liquid crystal display panel 30; optical sheets (not shown in drawings) such as a diffusion sheet provided between the liquid crystal display panel 30 and the backlight 40; a lower case 41a and an upper case 41b provided so as to house the liquid crystal display panel 30, the pair of polarizing plates 31a and 31b, the backlight 40, and the optical sheets therein; a lens member 43 provided in a frame shape in the periphery of the liquid crystal display panel 30 through the polarizing plate 31a and a bonding film 42; and a plastic film 45 provided so as to cover the surface of the lens member 43. In FIGS. 1 and 2, the dotted line in the respective liquid crystal display devices 50 indicates the inner periphery of the plastic film 45 bonded onto the surface of the lens member 43.

As shown in FIG. 3, the liquid crystal display panel 30 includes an active matrix substrate 10 and an opposite substrate 20 provided facing each other, a liquid crystal layer 15 provided between the active matrix substrate 10 and the opposite substrate 20, and a sealing member 16 provided in a frame shape so as to bond together the active matrix substrate 10 and the opposite substrate 20 and so as to seal the liquid crystal layer 15 between the active matrix substrate 10 and the opposite substrate 20. As shown in FIG. 3, the liquid crystal display panel 30 has a display region D for displaying images on the inner side of the sealing member 16.

The active matrix substrate 10 includes: an insulating substrate (not shown in drawings) such as a glass substrate; a plurality of gate lines (not shown in drawings) provided so as to extend in parallel with each other on the insulating substrate; a gate insulating film (not shown in drawings) provided so as to cover the respective gate lines; a plurality of source lines (not shown in drawings) provided on the gate insulating film so as to extend in parallel with each other in a direction perpendicular to the respective gate lines, a plurality of TFTs (thin film transistors; not shown in drawings) provided for each intersection of the respective gate lines and respective source lines, or in other words, for each subpixel, which is the minimum display unit; an interlayer insulating film (not shown in drawings) provided so as to cover the respective TFTs, a plurality of pixel electrodes (not shown in drawings) arranged in a matrix on the interlayer insulating film; and an alignment film (not shown in drawings) provided so as to cover the respective pixel electrodes, for example.

The opposite substrate 20 includes: an insulating substrate (not shown in drawings) such as a glass substrate; a black matrix (not shown in drawings) provided in a grid pattern on the insulating substrate; a plurality of colored layers (not shown in drawings) such as a red layer, a green layer, and a blue layer each provided within each of the grid cells in the black matrix; a common electrode (not shown in drawings) provided so as to cover the black matrix and the respective colored layers; a plurality of photospacers (not shown in drawings) provided in pillar shapes on the common electrode; and an alignment film (not shown in drawings) provided so as to cover the common electrode and the respective photospacers, for example.

The liquid crystal layer 15 is made of a nematic liquid crystal material that has electro-optic characteristics, for example.

The backlight 40 includes a light guide plate (not shown in drawings), a plurality of light sources (not shown in drawings) such as LEDs (light emitting diodes) provided along one side face of the light guide plate, and a reflective sheet (not shown in drawings) provided on the rear surface of the light guide plate, for example.

As shown in FIG. 3, the lower case 41a is provided so as to house therein a backlight 40, the lower portion in the drawing of the liquid crystal display panel 30, and the polarizing plate 31a, optical sheets, and the like disposed therebetween.

As shown in FIG. 3, the upper case 41b is provided so as to house therein the upper portion in the drawing of the liquid crystal display panel 30, and the upper portion in the drawing of the polarizing plate 31b, the side walls of the lower case 41a, and the like, and an opening 41bc is provided in the upper surface of the upper case 41b so as to expose a display region D of the liquid crystal display panel 40. As shown in FIG. 3, the liquid crystal display device 50 is provided with a display region D in the opening 41bc of the upper case 41b, and a frame region F is provided on the outside of the display region D.

As shown in FIG. 4, the lens member 43 is provided in a frame shape and includes four linear portions 43a, and four corner portions 43b that respectively connect adjacent linear portions 43a to each other. As shown in FIG. 3, the lens member 43 is provided so as to guide display light Lf in the periphery of the display region D of the liquid crystal display panel 30 along the outer side of the display region D or in other words the frame region F, due to the curved surface of the lens member 43.

As shown in FIG. 5, the linear portions 43a have a substantially semicircular cross-sectional shape, and are made of a transparent resin material such as an acrylic resin, for example. Also, as shown in FIGS. 3 and 5, in the linear portions 43a, portions thereof towards the display region D have a relatively shallow incline while the portions thereof towards the frame region F have a relatively steep incline.

As shown in FIG. 6, the corner portions 43b have a surface shape in which two different curved surfaces including the curved surface of the linear portion 43a extending in the vertical direction (refer to FIG. 4) and the curved surface of the linear portion 43a extending in the horizontal direction (refer to FIG. 4) are connected to each other, and the corner portions 43b are made of a transparent resin material such as an acrylic resin, for example.

The bonding film 42 is made of an ultraviolet curable or heat curable transparent resin material, for example.

As shown in FIG. 7, the plastic film 45a included in the film 45 includes a base film 1 that is heat-shrinkable, an antiglare film 2a provided as a reflection inhibitor film Sf on the front surface of the base film 1, and an adhesive film 3 provided on the rear surface of the base film 1. The plastic film 45 in FIGS. 1 to 3 is a plastic film 45a that has undergone heat-shrinkage on the surface of the lens member 43. In the present embodiment, the reflection inhibitor that mitigates reflection of external light Lo is constituted of the reflection inhibitor film Sf.

The base film 1 is a uniaxially or biaxially stretched film (approximately 100 μm in thickness, for example) made of polyvinyl chloride, polyethylene, polypropylene, polyethylene terephthalate, or the like.

The antiglare film 2a is a film (approximately 10 μm in thickness, for example) having a surface that has undergone roughness treatment (having an average roughness (Ra) of approximately 10 μm, for example) by sandblasting, embossing rolling, etching, or the like, for example. As shown in FIG. 3, the antiglare film 2a mitigates reflection of the external light Lo due to the surface shape thereof.

The adhesive film 3 is made of an acrylic resin material, for example.

In the present embodiment, a plastic film 45a including an antiglare film 2a as the reflection inhibitor film Sf was described as an example, but instead of the plastic film 45a, a plastic film 45b (refer to FIG. 8) including an antireflector film 2b as the reflection inhibitor film Sf, or a plastic film 45c (refer to FIG. 9) that includes a multilayer film 2 including the antiglare film 2a and the antireflector film 2b as the reflection inhibitor film Sf may be used.

Specifically, as shown in FIG. 8, the plastic film 45b includes a base film 1 that is heat-shrinkable, an antireflector film 2b provided as a reflection inhibitor film Sf on the front surface of the base film 1, and an adhesive film 3 provided on the rear surface of the base film 1.

As shown in FIG. 8, the antireflector film 2b has a first dielectric film 2ba having a relatively high index of refraction, and a second dielectric film 2bb having a relatively low index of refraction. Also, the antireflector film 2b has an optical interference layer formed therein by the multilayer film including a plurality of dielectric films having different indices of refraction from each other, and is designed to mitigate reflection of the external light Lo. Here, the first dielectric film 2ba and the second dielectric film 2bb are respectively approximately 0.1 μm in thickness and are made of various types of fluoropolymers or the like having different indices of refraction from each other, for example.

Also, as shown in FIG. 9, the plastic film 45c includes a base film 1 that is heat-shrinkable, a multilayer film 2 including an antiglare film 2a and an antireflector film 2b provided as a reflection inhibitor film Sf on the front surface of the base film 1, and an adhesive film 3 provided on the rear surface of the base film 1.

The liquid crystal display device 50 of the configuration above is configured such that when displaying images, the transmittance of light from the backlight 45 through the respective subpixels is adjusted by changing the orientation state of the liquid crystal layer 15 by applying a prescribed voltage at each subpixel to the liquid crystal layer 15 interposed between the respective pixel electrodes on the active matrix substrate 10 and the common electrode on the opposite substrate 20, and thus, as shown in FIG. 3, the display light Ld is emitted at the display region D and the display light Lf is emitted at the frame region F. In the frame region F of the liquid crystal display device 50, the display light Lf in the periphery of the display region D is magnified towards the outside (towards the frame region F) and emitted.

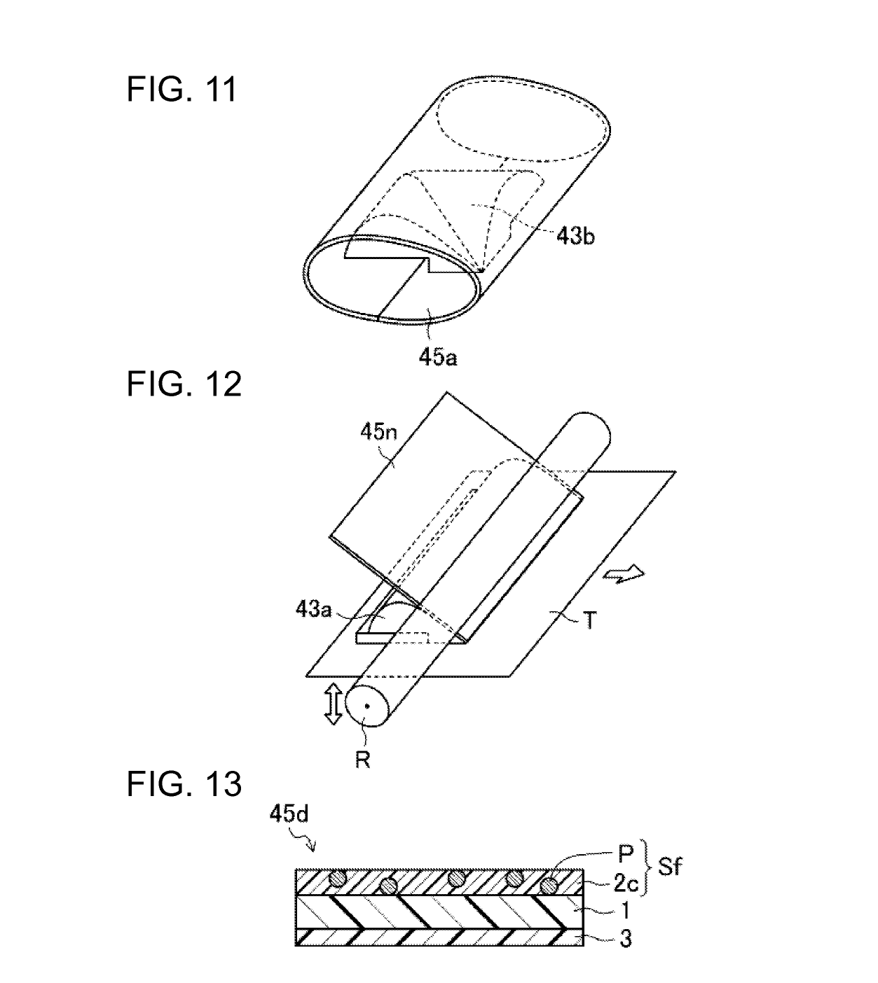

Next a manufacturing method for the liquid crystal display device 50 of the present embodiment will be described with reference to FIGS. 10 and 12. FIG. 10 is a perspective view showing a method to bond the plastic film 45a to the linear portion 43a of the lens member 43. FIG. 11 is a perspective view showing a method to bond the plastic film 45a to the corner portion 43b of the lens member 43. FIG. 12 is a perspective view showing another method to bond the plastic film 45a to the linear portion 43a of the lens member 43. The manufacturing method of the present embodiment includes a process of manufacturing a liquid crystal display panel, a process of assembling a case, a process of bonding a film, and a process of attaching a lens member.

<Process of Manufacturing Liquid Crystal Display Panel>

First, by a known method, gate lines, source lines, TFTs, pixel electrodes, and the like are formed on a glass substrate, thus forming a large active matrix mother substrate in which active matrix substrates 10 are arranged in a matrix.

Also, by a known method, a black matrix, color filters, a common electrode, and the like are formed on a glass substrate, thus forming a large opposite mother substrate in which opposite substrates 20 are arranged in a matrix.

Next, by using a dispenser, for example, a sealing members 16 are drawn in a frame shape on the surface of the respective opposite substrates 20 of the opposite mother substrate.

Then, a liquid crystal material (15) is dripped into areas surrounded by the sealing members 16 of the respective opposite substrates 20 of the opposite mother substrate upon which the sealing members 16 were drawn.

Then, after bonding the opposite mother substrate on which the liquid crystal material (15) was dripped to the active matrix mother substrate in a depressurized stated, the bonded opposite mother substrate and active matrix mother substrate are released into atmospheric pressure, thus pressurizing the respective surfaces of the active matrix mother substrate and the opposite mother substrate, and then, by curing the sealing members 16, a large bonded body is formed.

Then, the large bonded body is separated into separate cell units, thereby forming liquid crystal display panels 30, and then, polarizing plates 31a and 31b are respectively bonded to the rear surface and front surface of the liquid crystal display panel 30, and then, a TCP (tape carrier package), a PWB (printed wiring board), and the like are mounted thereon.

In this manner, the liquid crystal display panel 30 upon which the polarizing plates 31a and 31b are bonded and upon which the TCP, the PWB, and the like are mounted can be manufactured.

<Process of Insertion into Case>

The lower case 41a, the upper case 41b, the backlight 40, and the optical sheets are prepared. On the inside of the lower case 41a, a backlight 40, optical sheets, and the liquid crystal display panel 30 manufactured in the process of manufacturing a liquid crystal display panel and upon which the polarizing plates 31a and 31b are bonded are installed, and after fixing the backlight 40 and the liquid crystal display panel 30, the upper case 41b is embedded within the upper part of the side walls of the lower case 41a.

<Process of Bonding Film>

First, as shown in FIG. 10, inside a chamber of a heating device, the linear portion 43a is inserted into the plastic film 45a rolled into a cylinder, and the inside of the chamber is turned into a vacuum.

Next, the temperature inside the chamber is set (to approximately 100° C., for example), thus heating the plastic film 45a, and causing the plastic film 45a to undergo heat-shrinkage.

Then, the plastic film 45a on the bottom surface of the linear portion 43a is removed.

Also, as shown in FIG. 11, inside the chamber of the heating device, the corner portion 43b is inserted into the plastic film 45a rolled into a cylinder, and the inside of the chamber is turned into a vacuum.

Next, the temperature inside the chamber is set (to approximately 100° C., for example), thus heating the plastic film 45a, and causing the plastic film 45a to undergo heat-shrinkage.

Then, the plastic film 45a on the bottom surface of the corner portion 43a and on side walls standing upright from the bottom surface (adjacent to the linear portions 43a) is removed.

In the present invention, a method of bonding the plastic film 45a having heat-shrinking properties to the linear portion 43a was described as an example, but a plastic film (45n) that does not have heat-shrinking properties may be bonded to the linear portion 43a. Specifically, as shown in FIG. 12, the linear portion 43a is placed on a slidable table T, and then, while placing the plastic film 45n on the surface of the linear portion 43a and pressing a wall of an elevatable roll R thereon, a plastic film 45n is bonded onto the peripheral surface of the linear portion 43a. The plastic film 45n does not include a base film 1 having heat-shrinking properties in the plastic film 45a, for example, and is a general anti-reflective (inhibiting) film. Also, as shown in FIG. 12, the surface of the table T is formed in a step shape such that the bottom surface of the linear portion 43a fits thereon. Also, the table T is configured such that the linear portion 43a is in vacuum contact with the surface thereof.

In the present embodiment, an example was described of a manufacturing method in which a plastic film 45a is bonded onto the surface of the lens member 43 through an adhesive film 3 provided on the rear surface of the plastic film 45a, but the adhesive film 3 on the rear surface of the plastic film 45a may be omitted, and the surface of the lens member 43 may be coated with an ultraviolet curable or heat curable transparent resin material, for example, and after heat-shrinking the plastic film 45a, the resin material may be heated to a higher temperature than when heat-shrinking was performed, or ultraviolet rays may be radiated thereon.

In this manner, the lens member 43 (linear portion 43a and corner portion 43b) bonded to the plastic film 45a can be manufactured.

<Process of Attaching Lens Member>

On the upper surface of the upper case 41b into which the backlight 40, the liquid crystal display panel 30, and the like were previously inserted in the process of insertion into a case, and the periphery of the polarizing plate 31b exposed by the opening 41bc, an ultraviolet curable or heat curable transparent resin material is coated. After the lens member 43 to which the plastic film 45a was bonded in the process of bonding a film is disposed on the coating surface, the coating surface is irradiated with ultraviolet rays or heated, thus forming the bonding film 42, and thereby attaching the lens member 43 to the upper case 41b and the polarizing plate 31b. In the present embodiment, an ultraviolet curable or heat curable transparent resin material was described as an example of the bonding film 42, but a two-liquid type room temperature-curable resin material that is cured through natural drying may be used.

In this manner, the liquid crystal display device 50 of the present embodiment can be manufactured.

As described above, according to the plastic film 45a and the liquid crystal display device 50 of the present embodiment, in the plastic film 45a for mitigating reflection of external light Lo covering the surface of the lens member 43, the reflection of the external light Lo is mitigated by the reflection inhibitor film Sf provided on the base film 1, and the base film 1 has heat-shrinking properties, and thus, the plastic film 45a for mitigating reflection of the external light Lo is provided with heat-shrinking properties. Thus, when bonding the plastic films 45a to the surface of the lens member 43, the linear portions 43a and the corner portions 43b of the lens member 43 are respectively disposed inside the plastic films 45a rolled into a hollow cylinder, and in that state, the respective plastic films 45a are heated, thereby causing the base film 1 included in the plastic film 45a to undergo heat-shrinkage, and the plastic films 45a are evenly bonded to the respective bonding surfaces of the linear portions 43a and the corner portions 43b. In this manner, it is possible to bond the plastic films 45a with ease to the respective linear portions 43a and the respective corner portions 43b included in the lens member 43, and thus, even if the bonding surface of the lens member 43 is curved, it is possible to bond thereon the plastic films 45a for mitigating reflection of the external light Lo.

Also, according to the plastic film 45a of the present embodiment, the adhesive film 3 is provided on the rear surface of the base film 1, and thus, it is possible to dispose the adhesive film 3 with ease between the base film 1 included in the plastic film 45 for mitigating reflection of the external light Lo and bonding surface of the lens member 43 having a curved surface.

Also, according to the liquid crystal display device 50 of the present embodiment, the lens member 43 includes four linear portions 43a and four corner portions 43b, and thus, by bonding the plastic films 45a for mitigating reflection of the external light Lo to each of the linear portions 43a and each of the corner portions 43b included in the lens member 43, it is possible to bond the plastic films 45a to the lens member 43 with ease.

According to the multi-display device 60 of the present embodiment, in each liquid crystal display device 50, it is possible to bond with ease the plastic films 45a for mitigating reflection of external light Lo to the lens member 43 provided so as to cover the periphery of the liquid crystal display panel 30, and thus, the seams between the respective liquid crystal display devices 50 do not stand out (seamless), and therefore, it is possible to easily provide a larger display.

In the present embodiment, a liquid crystal display device 50 in which the outer periphery of the upper case 41b and the outer periphery of the lens member 43 that includes the plastic film 45a match in position was described as an example, but a liquid crystal display device in which the outer periphery of the lens member is on the inner side of the outer periphery of the case, or a liquid crystal display device in which the outer periphery of the lens member is disposed to the outside of the outer periphery of the case may be used.

### Embodiment 2

FIG. 13 is a cross-sectional view of a plastic film 45d of the present embodiment. In each embodiment below, the same components as those in FIGS. 1 to 12 are given the same reference characters, and the descriptions thereof are not repeated.

In Embodiment 1, an antiglare film 2a, an antireflector film 2b, and a multilayer film 2 including the antiglare film 2a and the antireflector film 2b as reflection inhibitor films (reflection inhibitor) Sf provided on the base film 1 were described as respective examples of plastic films 45a to 45c, but in the present embodiment, a plastic film 45d provided with a resin film 2c within which antiglare particles P are dispersed as the reflection inhibitor film (reflection inhibitor) Sf provided in the base film 1 is described as an example.

As shown in FIG. 13, the plastic film 45d includes a base film 1 that is heat-shrinkable, a resin film 2c provided as the reflection inhibitor film Sf on the surface of the base film 1, and an adhesive film 3 provided on the rear surface of the base film 1.

The resin film 2c is made of polyvinyl chloride, polyethylene, polypropylene, or the like, for example, and has thermoplasticity. The antiglare particles P are dispersed within the resin film 2c.

The antiglare particles P are made of silica particles with a diameter of approximately 3 μm, for example, and due to light dispersion on the surface thereof, the reflection of external light Lo is mitigated.

As described above, according to the plastic film 45d of the present embodiment, as in Embodiment 1, the plastic film 45d is provided with heat-shrinking properties, and thus, even if the bonding surface of the lens member 43 is a curved surface, it is possible to bond the plastic film 45d for mitigating reflection of the external light Lo thereon with ease.

Also, according to the plastic film 45d of the present embodiment, the reflection inhibitor film Sf includes the resin film 2c having thermoplasticity and provided on the surface of the base film 1 and the antiglare particles P dispersed within the resin film 2c. Thus, the plastic film 45d for mitigating reflection of the external light Lo includes the base film 1, and the resin film 2c having the antiglare particles P dispersed therein, the resin film 2c being layered on the base film 1. Therefore, even if the base film 1 has a high rate of heat-shrinkage, it is possible to have the resin film 2c (reflection inhibitor film Sf) conform to the heat-shrinkage of the base film 1 with ease.

### Embodiment 3

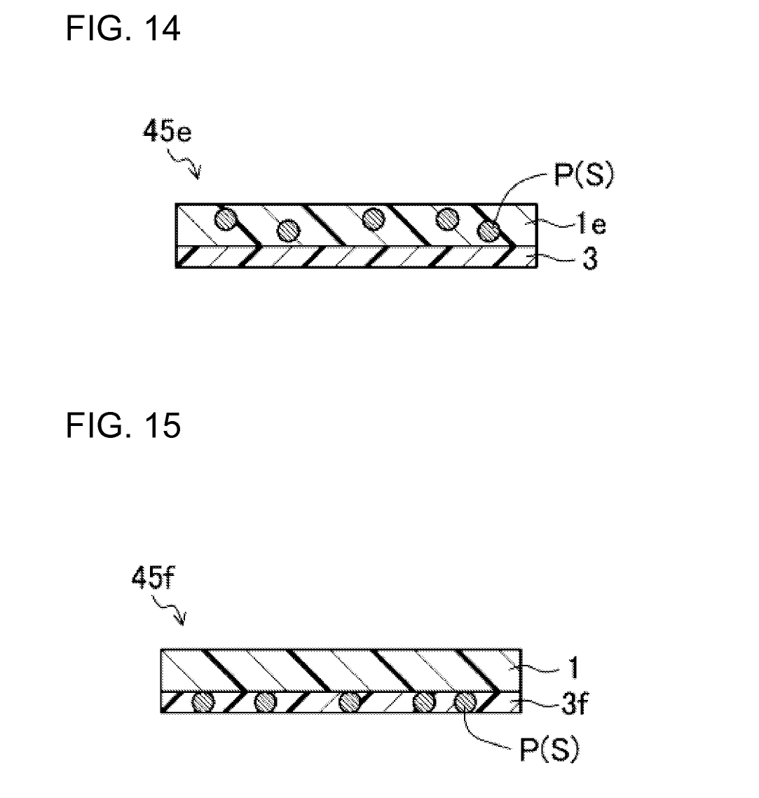

FIG. 14 is a cross-sectional view of a plastic film 45e of the present embodiment.

In Embodiment 2, an example was described of a plastic film 45d in which antiglare particles P are dispersed in the resin film 2c, but in the present embodiment, a plastic film 45e in which antiglare particles P are dispersed in a base film 1e will be described as an example.

As shown in FIG. 14, the plastic film 45e includes a base film 1e having thermoplasticity, antiglare particles P provided as reflection inhibitors S within the base film 1e, and an adhesive film 3 provided on the rear surface of the base film 1e.

The base film 1e is a uniaxially or biaxially stretched film (approximately 100 μm in thickness, for example) made of polyvinyl chloride, polyethylene, polypropylene, polyethylene terephthalate, or the like, for example.

As described above, according to the plastic film 45e of the present embodiment, as in Embodiments 1 and 2, the plastic film 45e is provided with heat-shrinking properties, and thus, even if the bonding surface of the lens member 43 is a curved surface, it is possible to bond the plastic film 45e for mitigating reflection of external light Lo thereon with ease.

According to the plastic film 45d of the present embodiment, the reflection inhibitors S are antiglare particles P dispersed in the base film 1e, and thus, even if the base film 1e has a high rate of heat-shrinkage, the reflection inhibitors S can easily conform to the heat-shrinkage of the base film 1e.

### Embodiment 4

FIG. 15 is a cross-sectional view of a plastic film 45f of the present embodiment.

In Embodiment 3, an example was described of a plastic film 45e in which antiglare particles P are dispersed in the base film 1e, but in the present embodiment, a plastic film 45f in which antiglare particles P are dispersed in an adhesive film 3f will be described as an example.

As shown in FIG. 15, the plastic film 45f includes a base film 1 having heat-shrinking properties, an adhesive film 3f provided on the rear surface of the base film 1, and antiglare particles P provided as reflection inhibitors S in the adhesive film 3f.

The adhesive film 3f is made of an acrylic resin material, for example.

As described above, according to the plastic film 45f of the present embodiment, as in Embodiments 1 to 3, the plastic film 45f is provided with heat-shrinking properties, and thus, even if the bonding surface of the lens member 43 is a curved surface, it is possible to bond the plastic film 45f for mitigating reflection of the external light Lo thereon with ease.

According to the plastic film 45f of the present embodiment, the reflection inhibitors S are antiglare particles P dispersed in the adhesive film 3f layered on the base film 1, and thus, even if the base film 1 has a high rate of heat-shrinkage, it is possible for the reflection inhibitors S to conform to the heat-shrinkage of the base film 1 with ease.

### Other Embodiments

In the Embodiments 2 to 4, plastic films 45d to 45f having antiglare particles P dispersed in a substantially uniform manner were described as examples, but the concentration of antiglare particles in the plastic film before it undergoes heat-shrinkage may be set such that the concentration of antiglare particles matches the surface shape of the bonding surface such that the concentration of antiglare particles is even when the plastic film is heat shrunk onto the bonding surface.

In the respective embodiments above, a liquid crystal display device was described as an example of a display device, but the present invention can be applied to another display device such as an organic EL (electroluminescence) display device, an inorganic EL display device, an electrophoretic display device, a plasma display (PD) device, a plasma addressed liquid crystal display (PALC) device, a field emission display (FED) device, a surface conduction electron-emitter display (SED) device.

Also, in the respective embodiments above, a display device using the color filter system was described as an example, but the present invention can be applied to a display device using the field sequential system.

### INDUSTRIAL APPLICABILITY

As described above, in the present invention, the plastic film for mitigating reflection of external light can be bonded with ease onto a bonding surface even if the bonding surface is a curved surface, and thus, the present invention is useful not only as a method to mitigate reflection provided in a lens member having a curved surface and a display device provided therewith, but as a method to mitigate reflection in a picture frame or a vase.

### DESCRIPTION OF REFERENCE CHARACTERS

D display region

Ld display light

Lo external light

P particle

S reflection inhibitor

Sf reflection inhibitor film (reflection inhibitor)

1, 1e base film multilayer film

2a antiglare film

2b antireflector film

2ba first dielectric film

2bb second dielectric film

2c resin film

3, 3f adhesive film

30 liquid crystal display panel

43 lens member

43a linear portion

43b corner portion

45, 45a to 45f plastic film

50 liquid crystal display device

60 multi-display device

1. A plastic film for being disposed on a surface of an object to mitigate reflection of external light by said surface, the plastic film comprising:
a base film having a heat-shrinking property; and
a reflection inhibitor in or on the base film that mitigates the reflection of said external light.

2. The plastic film according to claim 1, wherein the reflection inhibitor includes a reflection inhibitor film that is provided on a front surface of the base film and that mitigates reflection of external light.

3. The plastic film according to claim 2, wherein the reflection inhibitor film includes an antiglare film that is provided on the front surface of the base film and that has undergone roughening treatment, an antireflector film having a plurality of dielectric films that are layered, or a multilayer film having the antiglare film and the antireflector film layered in that order.

4. The plastic film according to claim 2, wherein the reflection inhibitor film includes a resin film having thermoplasticity that is provided on the front surface of the base film, and particles that are dispersed in the resin film and that mitigate reflection of external light by light dispersion at particle surfaces.

5. The plastic film according to claim 1, wherein the reflection inhibitor is constituted of particles that are dispersed in the base film and that mitigate reflection of external light by light dispersion at particle surfaces.

6. The plastic film according to claim 1,
wherein a rear surface of the base film is provided with an adhesive film, and
wherein the reflection inhibitor is constituted of particles that are dispersed in the adhesive film and that mitigate reflection of external light by light dispersion at particle surfaces.

7. The plastic film according to claim 1, wherein a rear surface of the base film is provided with an adhesive film.

8. A display device, comprising:
a display panel having a display region that performs image display;
a lens member that is provided in a frame shape so as to cover a periphery of the display panel and that guides display light in a periphery of the display region of the display panel towards an outside of the display region; and
a plastic film provided so as to cover a surface of the lens member, the plastic film including a base film that has been heat-shrunk to conform with the surface of the lens member and a reflection inhibitor in or on the base film that mitigates reflection of external light by the lens member.

9. The display device according to claim 8, wherein the lens member includes four linear portions constituting four sides of a rectangle, and four corner portions that respectively connect adjacent linear portions to each other.

10. A multi-display device, comprising a plurality of said display devices according to claim 8,
wherein the plurality of display devices are arranged in a matrix.
